(19) United States
(12) Patent Application Publication
(10) Pub. No.: US 2025/0074415 A1
(43) Pub. Date: Mar. 6, 2025

(54) SYSTEM AND METHOD FOR ADJUSTING A VEHICLE OPERATING PARAMETER BY PROCESSING TRAILER INFORMATION

(71) Applicant: GM Global Technology Operations LLC, Detroit, MI (US)

(72) Inventors: Bassam S. Shahmurad, Rochester Hills, MI (US); Xu Fang Zhao, LaSalle (CA); Gaurav Talwar, Novi, MI (US); Kenneth Ray Booker, Grosse Pointe Woods, MI (US)

(73) Assignee: GM Global Technology Operations LLC, Detroit, MI (US)

(21) Appl. No.: 18/458,542

(22) Filed: Aug. 30, 2023

(51) Int. Cl. B60W 30/16

(52) U.S. Cl. CPC B60W 30/16; B60W 2300/14; B60W 2420/403; B60W 2530/10; B60W 2530/201

(57) ABSTRACT

A system and method for adjusting an operating parameter of a vehicle by processing a trailer information includes a sensor and a controller. The vehicle includes a tow hitch configured to couple with a trailer. The sensor is configured to detect if the trailer is coupled to the tow hitch. The controller includes a data processing hardware and a memory hardware, the memory hardware storing instructions that when executed on the data processing hardware cause the data processing hardware to perform operations including processing the trailer information to change the vehicle operating parameter to a predetermined operating parameter if the trailer is coupled to the hitch.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a vehicle having a tow hitch configured to be coupled with a trailer. The trailer is towed by the vehicle and the load from the trailer may affect the driving operations of the vehicle. Thus, many vehicles include a driving mode for the operation of the vehicle without towing a trailer (a regular haul mode) and a driving mode for the operation of the vehicle when the vehicle is towing a trailer (a trailer haul mode). In the regular haul mode, the vehicle powertrain may be configured to generate less torque at acceleration relative to the trailer haul mode. Currently, the driving mode is selected manually by the user and, thus, the driving experience of the user may be undesirable in instances where a trailer is being towed and the vehicle is in a regular haul mode. For instance, if the combined weight of the trailer and cargo exceeds a predetermined value, a latency in the acceleration may occur if the vehicle is in a regular haul mode.

Further, the tow hitch is configured to couple with various different trailers and loads such as a simple flatbed trailer, a horse trailer, a recreational vehicle, a boat trailer and the like. Each of the trailers may have different characteristics such as weight, width, height and length, and the characteristics of the trailer may affect various vehicle operating parameters such as braking, acceleration, the available routes and the like. Further, the characteristics of the trailer may affect the operation of the vehicle differently. For example, the weight of the trailer may affect the stop distance of the brakes and the acceleration of the vehicle while physical characteristics such as the length and width of the trailer may inhibit travel along sharp turns, Further, the height of the trailer may prevent the trailer from traveling on roads having an underpass or a bridge with a height restriction.

Accordingly, it is desirable to tune the vehicle operating parameters of the vehicle based on the trailer information. Further, it is desirable to have a system and method in which the trailer information may be stored so as to facilitate the adjustment of the vehicle operating parameters.

### SUMMARY

In one configuration, a system for adjusting an operating parameter by processing trailer information includes a sensor and a controller. The vehicle includes a tow hitch configured to be coupled with a trailer. The sensor is configured to detect if a trailer is coupled to the tow hitch of the vehicle. The controller includes a data processing hardware and a memory hardware, the memory hardware storing instructions that when executed on the data processing hardware cause the data processing hardware to perform operations including processing the trailer information to change the vehicle operating parameter to a predetermined operating parameter if the trailer is coupled to the hitch.

The system may include one or more of the following optional features. For example, the trailer information may be one of a trailer type, a trailer length, a trailer height, a trailer width and a trailer weight. For example, in one aspect, the sensor is configured to detect the trailer weight. In another aspect, the sensor is configured to detect the width of the trailer and the height of the trailer. In yet another aspect, the sensor is an optical device configured to detect the height and width of the trailer.

In one configuration of the system, the predetermined operating parameter is a driving mode. In such a configuration, the driving mode may be a trailer haul mode.

In one configuration, the vehicle operating parameter may be a cruise control function, whereby the controller is configured to turn off the cruise control function of the vehicle if the trailer is coupled to the hitch. It should be appreciated that the predetermined operating parameters disclosed herein are not exhaustive but illustrative. For instance, the predetermined operating parameter of the vehicle may be a navigation route and/or a brake coefficient. In instances where the predetermined operating parameter is a navigation route, the controller generates the navigation route by processing the trailer information. In the case where the predetermined operating parameter is a brake coefficient, the controller may adjust the brake coefficient based upon the trailer information.

In another configuration, a method for adjusting an operating parameter of a vehicle having a tow hitch configured for coupling with a trailer is provided. The operating parameter of the vehicle may be adjusted by processing a trailer information. The method includes detecting if a trailer is coupled to the hitch of the vehicle and processing the trailer information to change the vehicle to a predetermined operating parameter if the trailer is coupled to the hitch. The trailer information may be at least one of a trailer type, a trailer length, a trailer, height, a trailer width, and a trailer weight.

In one configuration, the predetermined operating parameter is a driving mode. In such a configuration, the driving mode may be a trailer mode.

Additionally or alternatively, the method may include determining if the vehicle is in a regular haul mode or a trailer haul mode and alerting a user that the vehicle is in a regular haul when the trailer is coupled to the hitch.

In one configuration, the method may include determining if a cruise control function of the vehicle is on and automatically turning off the cruise control function if the trailer is coupled to the hitch.

In yet another configuration, the predetermined operating parameter may be a navigation route and/or a brake coefficient and the controller generates the navigation route and adjusts the brake coefficient by processing the trailer information. In one aspect, the controller generates a plurality of navigation routes for selection by a user, each of the plurality of navigation routes may include a notice for a sharp turn.

### BRIEF DESCRIPTION OF THE DRAWINGS

The drawings described herein are for illustrative purposes only of selected configurations and are not intended to limit the scope of the present disclosure.

FIG. 1 is a perspective schematic view of a tow system according to the present disclosure showing a vehicle in communication with a network and a mobile device;

FIG. 2 is a functional block diagram of an example tow system providing communication between a controller and vehicle components according to the present disclosure;

FIG. 3A is a depiction of a mobile device displaying a menu used in operation of the tow system shown in FIG. 1;

FIG. 3B is a depiction of a head unit displaying a menu used in operation of the tow system shown in FIG. 1;

FIG. 4A is a depiction of a mobile device providing a selection of trailer profiles to be selected for use in the tow system shown in FIG. 1;

FIG. 4B is a depiction of a head unit of a vehicle providing a selection of trailer profiles to be selected for use in the tow system shown in FIG. 1;

FIG. 5A is a depiction of a mobile device providing an option to add or remove a trailer for use in the tow system shown in FIG. 1;

FIG. 5B is a depiction of a head unit providing an option to add or remove a trailer for use in the tow system shown in FIG. 1;

FIG. 6A is a depiction of a mobile device providing a list of profiles to be removed from the memory hardware;

FIG. 6B is a depiction of a head unit providing a list of profiles to be removed from the memory hardware;

FIG. 7A is a depiction of a mobile device providing a selection of trailer information for input into the tow system shown in FIG. 1;

FIG. 7B is a depiction of a head unit providing a selection of trailer information for input into the tow system shown in FIG. 1;

FIG. 8 is a functional block diagram of an example adjustment of a vehicle operating parameter by processing trailer information according to the present disclosure; and

FIG. 9 is a flow chart showing a method for adjusting a vehicle operating parameter by processing trailer information according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A system and method for adjusting an operating parameter of a vehicle by processing trailer information includes a sensor and a controller. The vehicle includes a tow hitch configured to couple with a trailer. The sensor is configured to detect a coupling of the trailer. The sensor may be further configured to detect trailer information to include the length, height, width, weight and the like. The trailer information is processed by the controller to adjust the operating parameter of the vehicle to a predetermined operating parameter, thereby tuning the operation of the vehicle in accordance with the weight, length, width, height, and cargo weight of the trailer. Additionally, the controller may be configured to automatically select the predetermined operating parameter or prompt the user to select the predetermined operating parameter. As used herein, the term “operating parameter” refers to a vehicle component or system, singularly or in combination with other vehicle components and/or systems, that influence a control and/or travel of the vehicle such as the engine, brake, navigation system, cruise control and the like. Thus, the operating parameters recited herein are illustrative and not exhaustive.

Further, the system and method described herein may be customized to the user and store a plurality of trailers. Each trailer may be associated with its own trailer information. In such an aspect, the system and method adjusts the vehicle operating parameters based upon the selected trailer, thereby providing an operating parameter that is tuned to the trailer information of the attached trailer.

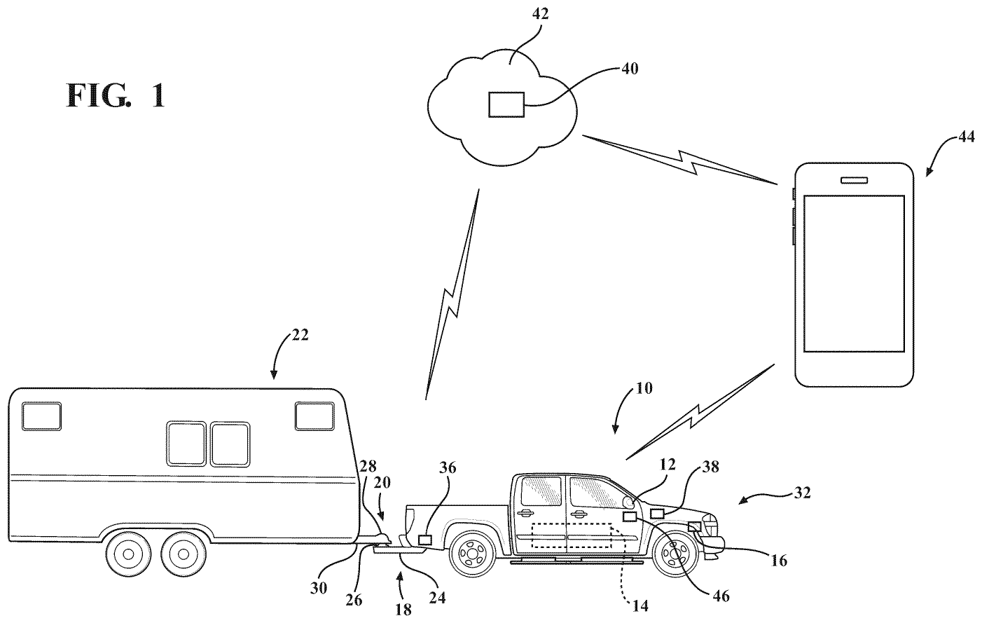

With reference to FIG. 1 a vehicle 10 includes a vehicle body 12 and known systems and components for propelling and controlling the movement of the vehicle 10, such as a powertrain 14, a brake 16, a steering wheel (none shown) and the like. The vehicle 10 may include systems for controlling the vehicle operating parameters such as regular haul mode, a trailer haul mode, an Advanced Driver Assistance Systems (“ADAS”), a cruise control system, an anti-lock braking system, a navigation system and the like.

The vehicle 10 includes a tow hitch 18 configured to couple with a coupling mechanism 20 of a trailer 22. For illustrative purposes, the tow hitch 18 is shown as a receiver-type hitch and includes a support 24 that may be removably inserted into a receiver (none shown) of the vehicle 10. The receiver is mounted to a rear end of the frame or chassis member of the vehicle 10 via bolts or other fasteners. The tow hitch 18 further includes a tow ball 26 configured to be coupled to the coupling mechanism 20 of the trailer 22. The coupling mechanism 20 is illustratively shown as a socket 28 mounted to a tongue 30 of the trailer 22, and may include a mechanism (none shown) for securing the tow ball 26 into the socket 28. It should be appreciated that other styles of hitch systems, such as fixed drawbar hitch systems, for example, may also be used. The tow hitch 18 is provided for exemplary purposes only and does not narrow the scope of the appended claims.

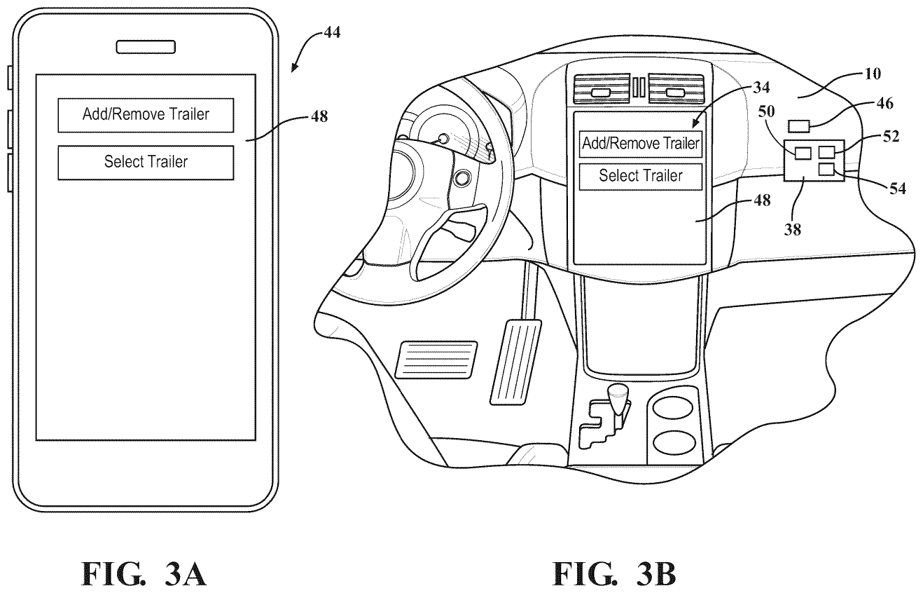

The vehicle 10 includes a tow system 32 configured to adjust the operating parameters of the vehicle 10. The tow system 32 may be implemented in a software application having an operating unit written in a head unit 34 of the vehicle 10. The tow system 32 includes a sensor 36 and a controller 38. The operating unit provides a set of instructions to be executed by the controller 38. The tow system 32 is configured to place the head unit 34 (shown in FIG. 3B) in communication with a host program 40 that resides in a server 42 external to the vehicle 10 and/or a mobile device 44. The head unit 34 may be in wireless communication with the host 40 and the mobile device 44 using a transmission device 46 of the vehicle 10. The transmission device 46 may be a transceiver antenna for receiving and transmitting data between the head unit 34, the server 42, and the mobile device 44. The transmission device 46 may also include a Bluetooth® transceiver for receiving and transmitting data between the head unit 34 and the mobile device 44. A software application may be downloaded onto the mobile device 44 for inputting information to the controller 38 residing in the head unit 34.

The tow system 32 is configured to adjust an operating parameter of a vehicle 10 by processing trailer information. The operating parameter of the vehicle 10 may be a haul mode, a navigation route, and/or a brake coefficient. As used herein, the term “trailer information” means a condition of the trailer 22, such as if the trailer 22 is coupled to the tow hitch 18, as well as physical characteristics of the trailer 22 such as the weight, height, length, width and cargo weight of the trailer 22. In one aspect, the tow system 32 is configured to process the trailer information and automatically adjust an operating parameter of the vehicle 10. In another aspect, the tow system 32 processes the trailer information and provides a prompt or notification to the user allowing the user to manually select the operating parameter of the vehicle 10. It should be appreciated that the tow system 32 may be configured to automatically adjust specific vehicle operating parameters while prompting the user to select other vehicle operating parameters. It should be appreciated that the operating parameters disclosed herein are illustrative and not exhaustive.

The sensor 36 is configured to detect trailer information, such as if the trailer 22 is coupled to the tow hitch 18 of the vehicle 10 and the controller 38 is configured to process data from the sensor 36 to adjust the operating parameter of the vehicle 10. The sensor 36 may be further configured to detect at least one or more different types of trailer information. Any sensor 36 currently known or later developed may be modified for use herein, illustratively including a load sensor, tension sensor or the like. It should be appreciated that the sensor 36 may determine if the trailer 22 is coupled to the tow hitch 18 by measuring a load on the tow ball 26 and/or the support 24. In one aspect, trailer information such as cargo weight or trailer weight may be calculated by processing data detected by the sensor 36 with information relating to the operation of the vehicle 10. For instance, the weight of the trailer 22 may be processed by the load detected by the sensor 36 and the operation of the engine with respect to an acceleration demand by the user. Such a calculation is well known to those skilled in the art and a detailed description of such a calculation is not required.

The sensor 36 may be a sensor unit including one or more sensors 36 of different capabilities. For instance, the sensor 36 may include a first sensor 36a and a second sensor 36b. The first sensor 36a is configured to detect a load applied to the tow ball 26 and the second sensor 36b is configured to detect a trailer height and width. The second sensor 36b may be an optical sensor such as a camera or LIDAR sensor, in which case, image processing is performed by the controller 38 to calculate a width and a height of the trailer 22.

The tow system 32 may further include an input 48 (shown in FIGS. 3A-8B) for manually entering trailer information that may not be calculated or otherwise detected by the sensor 36. For instance, the user may actuate the input 48 to enter trailer information such as the trailer length and cargo weight. The tow system 32 may be configured to allow the user to override trailer information detected by the sensor 36. For instance, when the sensor 36 detects trailer information such as a height of the trailer 22, the user may manually enter the height to override the trailer information obtained by the sensor 36. Such an aspect may be beneficial in instances where a tire size of the trailer 22 and/or the vehicle 10 has changed.

The controller 38 includes a data processing hardware 50 and a memory hardware 52. The memory hardware 52 stores instructions that when executed on the data processing hardware 50 cause the data processing hardware 50 to perform operations including processing the trailer information to change the vehicle operating parameter to a predetermined operating parameter if the trailer 22 is coupled to the tow hitch 18. In one aspect, the controller 38 is configured to prompt the user to accept the predetermined operating parameter. In another aspect, the controller 38 automatically changes the vehicle operating parameter to the predetermined operating parameter.

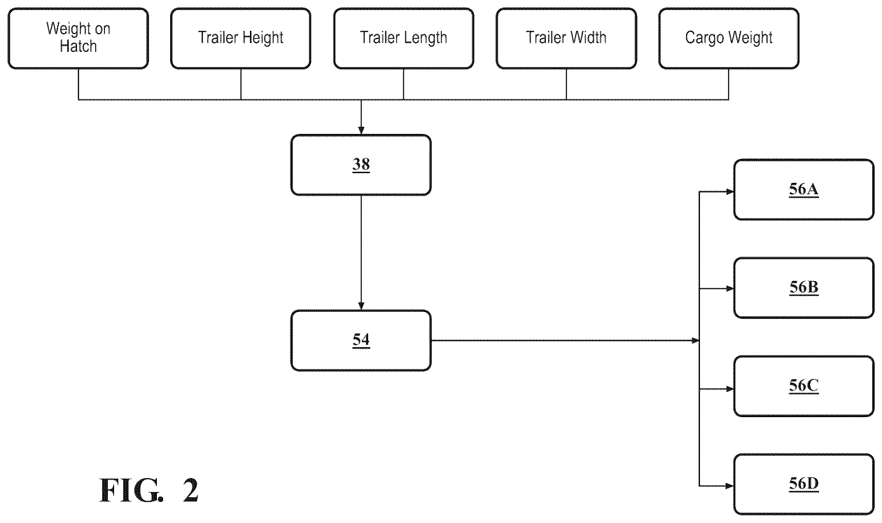

With reference now to FIG. 2, the trailer information is retrieved by the controller 38 and transmitted to a controller area network 54 for distribution to at least one of a plurality of control units for controlling a vehicle operating parameter. For example, the controller 38 may transmit a trailer height, width, and length to a navigation control unit 56A. The navigation control unit 56A processes the trailer height, width, and length to generate a route that is not impeded by the trailer height, width, and length and/or to provide the user with locations along the generated route having a sharp turn. In such an example, the trailer height may be processed to identify any underpasses or tunnels that may not accommodate the height of the trailer 22 and generate a route that bypasses the identified underpass and/or tunnel. Additionally, the trailer width and length may be processed to locate turns that may require the vehicle 10 to significantly reduce its speed to navigate the turn safely.

As discussed above, one of the vehicle operating parameters may be a haul mode. In such an aspect, the vehicle 10 is configured to drive in a regular haul mode or a trailer haul mode. In the regular haul mode, the components of the vehicle 10 responsible for propelling and controlling the movement of the vehicle 10 such as the vehicle 10 powertrain 14 and the brakes 16 may be configured to operate without the load associated with towing a trailer 22. For instance, in the regular haul mode, the powertrain 14 is configured to move through the various transmission gears without consideration of the load of the trailer 22. In the trailer haul mode, the powertrain 14 is configured to generate more torque to facilitate pulling the load associated with the trailer 22. Additionally, the brakes 16 may be set to generate a greater coefficient of friction in a trailer haul mode relative to a regular haul mode to shorten the stopping distance of the vehicle 10 when hauling a trailer 22. Accordingly, the controller 38 may transmit trailer information such as the trailer weight and cargo weight to a haul mode ECU 56B and/or a brake ECU 56C.

In instances where the vehicle 10 includes a cruise control system, the controller 38 transmits the trailer information to a cruise control ECU 56D. In one aspect, the sensor 36 deternines that the trailer 22 is coupled to the tow hitch 18 and the controller 38 may be configured to automatically transmit the data from the sensor 36 to the cruise control ECU 56D to automatically disable the cruise control operation of the vehicle 10. For instance, if the weight of the trailer 22, the weight of the cargo, and the width and length of the trailer 22, either singularly or in combination, exceed a predetermined value, the controller 38 may automatically transmit the trailer information to the cruise control ECU 56D to disable the cruise control operation of the vehicle 10. Alternatively, the controller 38 may be configured to notify the user that the cruise control is on and the user can decide to turn off the cruise control or keep the cruise control on. In such an aspect, the controller 38 may generate a text display on the head unit 48 notifying the user that the cruise control is on. It should be appreciated that the haul mode ECU 56B, the brake ECU 56C, and the cruise control ECU 56D are shown as separate units for illustrative purposes but the haul mode ECU, the brake ECU 56C, and the cruise control ECU 56D may be integrated into a single unit such as a body control module of the vehicle 10.

With reference now to FIGS. 3A and 3B, the mobile device 44 and/or the head unit 34 may function as an input 48 for entering the trailer information. The software application includes a home page that may be displayed on a display of the head unit 34 and/or the display of the mobile device 44. The home page includes a menu that may be selected by actuating the mobile device 44 or the head unit 34. For instance, the display of the head unit 34 and the display of the mobile device 44 may be a touchscreen display. It should be appreciated that the head unit 34 and the mobile device 44 may include other mechanisms and means for entering trailer information, such as a keyboard, microphone, electronic stylus and the like. Upon selection of the menu, a drop-down menu appears and a list of options are available for selection. For illustrative purposes, the list of options includes an option to “Add/Remove Trailers” and an option to “Select Trailer 22”.

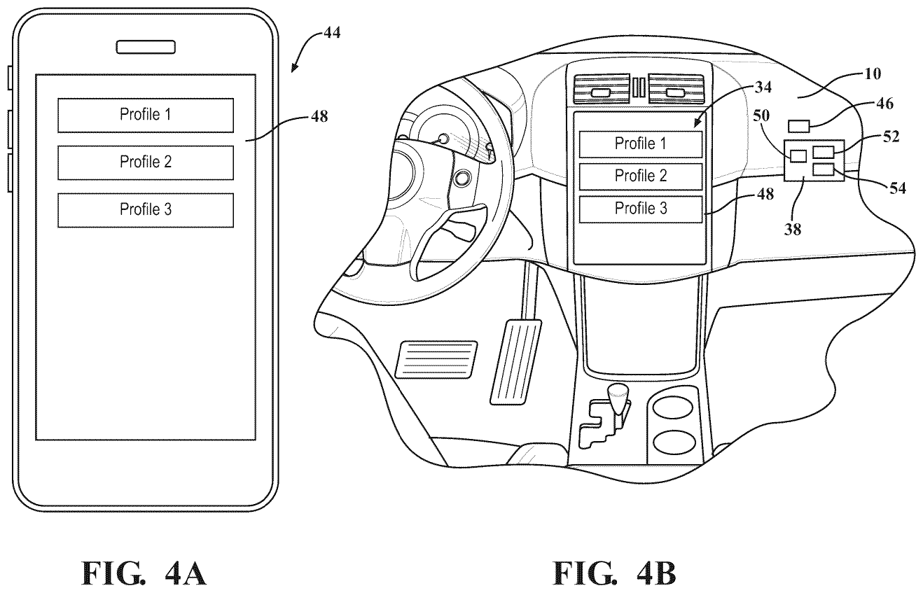

With reference now to FIGS. 4A and 4B, the user has selected the option “Select Trailer 22” and a list of trailer profiles (“Profile 1”. “Profile 2”, “Profile 3”), which have been saved in the memory hardware 52, is displayed. The user may then select the trailer profile corresponding to the trailer 22 that is currently coupled to or intended to be coupled with the tow hitch 18. Upon selection of a trailer profile, the tow system 32 adjusts the vehicle operating parameters by processing the trailer information associated with the selected trailer profile. In such an aspect, the tow system 32 may be configured to display a confirmation that the selected trailer profile is the appropriate trailer profile when the sensor 36 detects that a trailer 22 is coupled to the tow hitch 18. In addition, the controller 38 may process vehicle information to confirm that the selected trailer 22 is actually coupled to the tow hitch 18. For example, if the selected trailer 22 is a horse trailer 22 having a trailer weight of 1,500 pounds and a cargo weight of 1,000 pounds but the sensor 36 detects that the trailer weight is 500 pounds and the cargo weight is 200 pounds, the controller 38 may prompt the user to confirm the selected trailer 22 is the actual trailer 22 coupled to the tow hitch 18. It should be appreciated that other vehicle information may be used to display the prompt confirming the selected trailer 22 such as the output torque of the engine, operation of the transmission and the like wherein the engine and transmission behave in a manner that is inconsistent with the trailer information of the selected trailer profile.

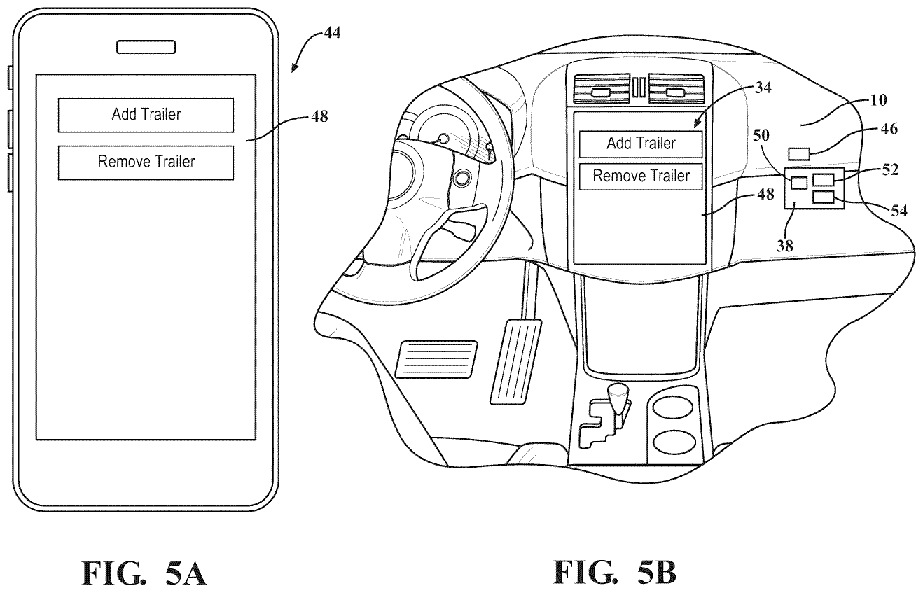

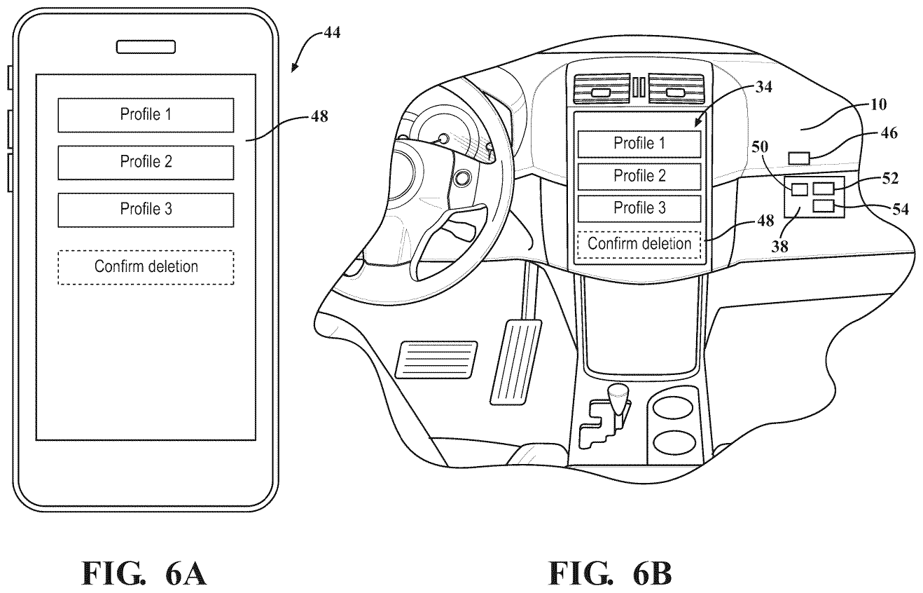

With reference now to FIGS. 5A-8B, the tow system 32 is further configured to allow the user to add and remove trailer profiles. With reference first to FIGS. 5A and 5B, the display of the mobile device 44 and the display of the head unit 34 includes two prompts. One of the prompts is “Add Trailer” and the other prompt is “Remove Trailer.” With reference now to FIGS. 6A and 6B, the user has selected the “Remove Trailer” prompt and a list of trailer profiles is displayed. The user may simply select a trailer profile for removal. The controller 38 may be further configured to display a confirmation of the selected trailer profile to be deleted. For instance, a display stating “Confirm Deletion” may appear after a trailer profile is selected, and upon touching the display, the controller 38 deletes the selected trailer profile from the memory hardware 52. Such a feature may be helpful in reducing the storage requirement of the memory hardware 52.

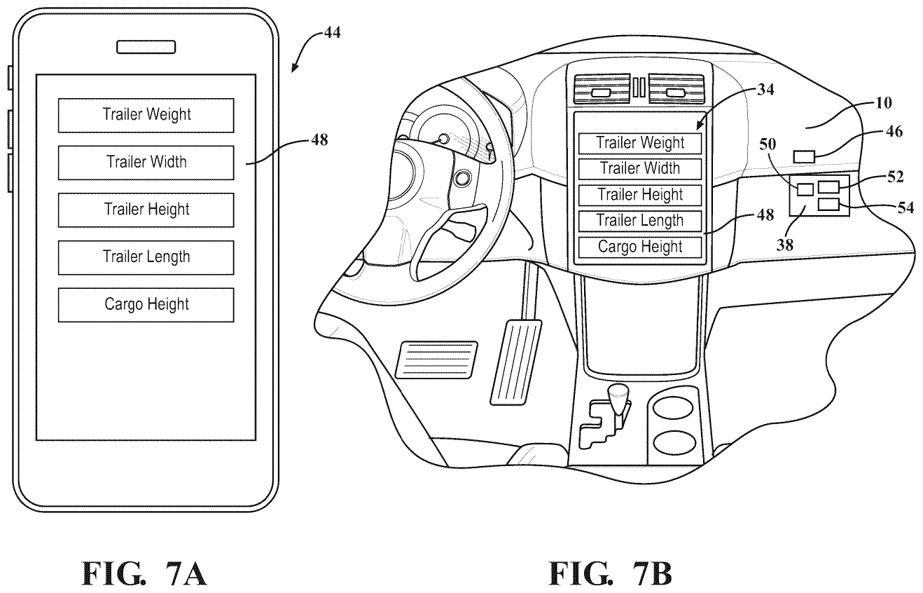

With reference now to FIGS. 7A and 7B, the user has selected the option “Add Trailer” and a list of trailer information is displayed. For illustrative purposes, the list of trailer information is shown as being “Trailer weight,” “Trailer Width,” “Trailer height,” “Trailer length,” and “Cargo Weight.” The user may simply select an information and enter the information using the mobile device 44 or the head unit 34, whereby the information is stored and saved in the memory hardware 52. It should be appreciated that in instances where the mobile device 44 is used to add a trailer profile and enter trailer information, or remove a trailer profile, the information is updated in the head unit 34, the mobile device 44, and the host program 40.

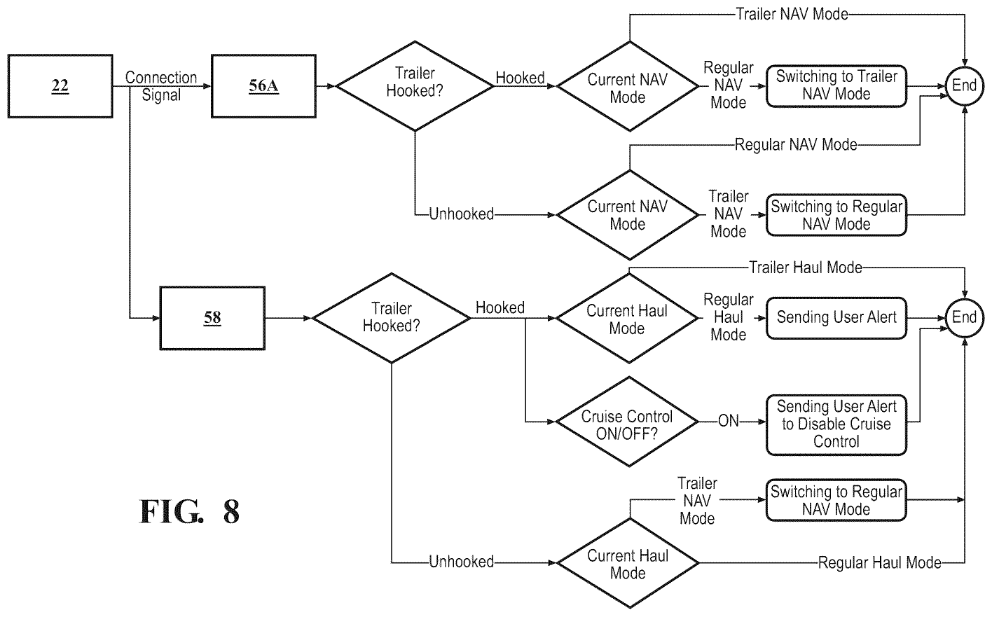

With reference now to FIG. 8, an operation of the tow system 32 is provided. For illustrative purposes, the operation of the tow system 32 will be described in the context of a mobile device 44 and/or the head unit 34 being used to confirm, select, and add information as the case may be. The vehicle 10 may include inputs (none shown) such as buttons or dials disposed on the instrument panel, steering wheel or the like for selecting a vehicle operating parameter. For instance, the user may actuate a button on the instrument panel to select between a regular navigation mode and a trailer navigation mode, or a regular haul mode or a trailer haul mode. The vehicle operating parameter may also be selected using the head unit 34. In one aspect, the vehicle 10 may be configured to stay in the last mode the vehicle was in when the vehicle 10 was turned off. For instance, if the vehicle 10 was in a trailer navigation mode when turned off, the vehicle 10 remains in the trailer navigation mode when turned back on. In the regular navigation mode, a route may be generated based upon factors such as the shortest distance to the desire destination, the shortest time to the destination, avoiding tolls to the destination and the like. In the trailer navigation mode, the route may be generated based upon the same factors as used in the regular navigation mode and also trailer information to assist the user in reaching the destination safely.

The wire harness of the trailer 22 is connected to the vehicle 10 and the controller 38 determines if a connection signal indicating that the wire harness is coupled is received. The controller 38 transmits the connection signal to various vehicle control units through the gateway of the controller area network 54. The sensor 36 detects that a trailer 22 has been coupled to the tow hitch 18. In the case where the user has not selected a trailer profile, the controller 38 may process data from the sensor 36 to select a trailer profile that matches the information detected by the sensor 36. For instance, in aspects where the sensor 36 detects a load on the hitch, the controller 38 may process the load to calculate a trailer weight and select the trailer profile that matches the calculated trailer weight. In instances where the sensor 36 is a sensor unit having a first sensor 36a and a second sensor 36b, the sensor 36 is configured to detect both a load and a width and/or height of the trailer 22, the controller 38 selects the trailer profile that matches the calculated weight, the detected width, and the detected height of the trailer 22. The controller 38 may be further configured to display a prompt asking the user to confirm the selected trailer profile.

The sensor 36 determines if the trailer 22 is coupled or uncoupled to the tow hitch 18 and the controller 38 transmits a coupling and uncoupled signal to various vehicle control units. For example, the controller 38 transmits the coupling signal to the navigation control unit 56A and the body control module 58. The navigation control unit 56A determines the current navigation mode of the vehicle 10. In instances where the trailer 22 is coupled and the current navigation mode is a trailer navigation mode, the controller 38 keeps the vehicle 10 operating in the trailer navigation mode. In instances where the trailer 22 is coupled and the current navigation mode is a regular navigation mode, the controller 38 instructs the navigation control unit 56A to change the navigation mode to a trailer navigation mode. In the trailer navigation mode, the navigation control unit 56A processes the trailer information to generate routes for the vehicle 10. The routes are configured to avoid roads that may have a weight restriction that exceeds the combined trailer weight and cargo weight, avoid roads that have an underpass or a bridge having a height that is less than the height of the trailer 22, and identifies turns and corners in the route that require the vehicle 10 to slow down to safely navigate the turn and corner.

If the sensor 36 detects that the trailer 22 is not coupled to the tow hitch 18, the controller 38 transmits the uncoupled signal to navigation control unit 56A and the navigation control unit 56A determines the current navigation mode of the vehicle 10. If the current navigation mode of the vehicle 10 is in a regular navigation mode, the navigation control unit 56A keeps the vehicle 10 in the regular navigation mode. If the current navigation mode of the vehicle 10 is in a trailer navigation mode, the navigation control unit 56A changes the vehicle 10 to the regular navigation mode. Thus, routes are generated without processing trailer information.

The controller 38 may be further configured to send a coupled and uncoupled signal to a body control module 58, which may be responsible for determining the haul mode of the vehicle 10 and the cruise control function of the vehicle 10. If the controller 38 transmits an uncoupled signal, the body control module 58 may determine the current haul mode of the vehicle 10. If the vehicle 10 is in a trailer haul mode, the controller 38 instructs the body control module 58 to change the haul mode to a regular haul mode.

When the controller 38 transmits a coupled signal to the body control module 58, the body control module 58 determines if the cruise control is on or off. If the cruise control is on, the controller 38 may instruct the body control module 58 to automatically turn off the cruise control or send an alert to the user to turn off the cruise control. For example, the controller 38 may generate a display on the head unit 34 alerting the user to turn off the cruise control. The controller 38 may process the trailer information to determine whether to automatically turn off the cruise control or send the alert. For example, the controller 38 may automatically turn off the cruise control in instances where the trailer information exceeds a predetermined value such as the trailer length is greater than 15 feet, the cargo weight is greater than 1,500 pounds or the trailer weight is greater than 2,000 pounds.

The body control module 58 may also process the coupled signal to determine the haul mode of the vehicle 10. If it is determined that the vehicle 10 is in a trailer haul mode, the controller 38 instructs the body control module 58 to stay in the trailer haul mode. If it is determined that the vehicle 10 is in a regular haul mode, the controller 38 may instruct the body control module 58 to automatically switch the haul mode from regular haul mode to trailer haul mode or send an alert to the user to manually switch the haul mode to trailer haul mode. The controller 38 may process the trailer information to determine whether to automatically switch the haul mode from regular haul mode to trailer haul mode or send an alert. For example, the controller 38 may automatically switch the haul mode to trailer haul mode in instances where the trailer information exceeds a predetermined value such as the cargo weight is greater than 1,500 pounds or the trailer weight is greater than 2,000 pounds.

In yet another aspect of the tow system 32, the controller 38 may process the trailer information to adjust a brake coefficient. As is known, the brake coefficient affects the stopping distance of the vehicle 10. Currently, the user may manually adjust the brake coefficient by setting a value to the brake 16. For instance, the vehicle 10 may provide the user with a range from 1-10, where one (1) is the smallest coefficient and ten (10) is the largest coefficient. The user may select a value by testing the brakes 16 and setting a value that provides a desired output. For instance, if the user feels that the trailer 22 is pushing the vehicle 10 when braking, the user may increase the brake coefficient. In instances where the user feels the trailer 22 is pulling the vehicle 10 when braking, the user may decrease the brake coefficient. The controller 38 may be configured to process the trailer information to calculate a brake coefficient and adjust the manually set brake coefficient to the calculated brake coefficient when the sensor 36 detects that the trailer 22 is coupled to the tow hitch 18. For example, if the cargo weight and the trailer weight exceed a predetermined value, such as 5,000 pounds, the brake coefficient may be increased.

The tow system 32 may be further configured to process the trailer information to provide a parking alert. For instance, the tow system 32 may process the weight of the trailer 22 and the weight of the cargo and map information or gyroscopic information to alert the user that the vehicle 10 may be parked in an area that is too steep for the load of the trailer 22. As an example, the controller 38 may display an alert on the head unit 34 if the vehicle 10 is parked on a 30 degree incline and is coupled to a trailer 22 having a combined weight of 10,000 pounds. Thus, the user may find a parking space that is more suitable for a vehicle 10 pulling 10,000 pounds.

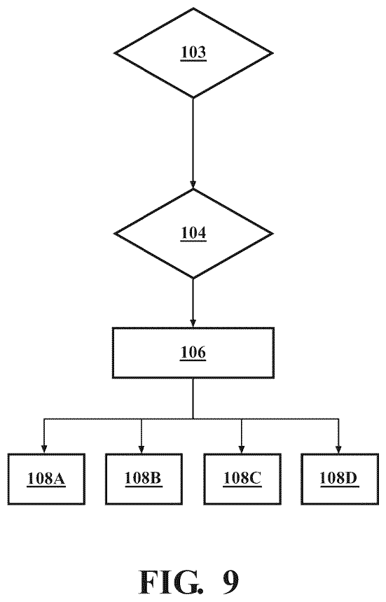

With reference now to FIG. 9, a method 100 for adjusting an operating parameter of a vehicle 10 by processing trailer information is described. The method 100 may be implemented by a software application having a controller 38 that processes vehicle information and trailer information to adjust the operating parameter of the vehicle 10. At block 102, the method 100 includes receiving a signal indicating that the trailer 22 is electrically connected to the vehicle 10, which may be done by connecting a trailer wire harness to the vehicle 10. At block 104, the method 100 includes detecting if a trailer 22 is coupled to the tow hitch 18 of the vehicle 10, which may be done by a sensor 36 that is configured to detect a load on the tow hitch 18. At block 106, the method 100 includes processing the trailer information to change the operating parameter of the vehicle 10 to a predetermined operating parameter if the trailer 22 is coupled to the tow hitch 18. The trailer information may be at least one of a trailer type, a trailer length, a trailer height, a trailer width, a trailer weight, and a cargo weight.

At block 108A, the predetermined operating parameter of the vehicle 10 is a haul mode. For instance, the vehicle 10 may be in a regular haul mode or a trailer haul mode. In one aspect of the method 100, the vehicle 10 is automatically changed from a regular haul mode to a trailer haul mode when the trailer 22 is coupled to the tow hitch 18. However, the method 100 may include determining if the vehicle 10 is in a regular haul mode or a trailer haul mode and alert a user that the vehicle 10 is in a regular haul mode when the trailer 22 is coupled to the hitch.

At block 108B, the predetermined operating parameter of the vehicle 10 is a cruise control function of the vehicle 10. At block 108B, the method 100 includes determining if the cruise control is on and automatically turning off the cruise control function if the trailer 22 is coupled to the toe hitch 18. However, the method 100 may include providing a notice to the user that the cruise control is on and suggesting to the user to turn off the cruise control. This may be done by a text display on the head unit 34 of the vehicle 10.

At block 108C, the predetermined operating parameter is a brake coefficient of the vehicle 10. In such an aspect, the brake coefficient is manually set by the user and the method 100 includes processing the trailer information to adjust the brake coefficient set by the user. In one aspect, the brake coefficient is calculated using the trailer information such as the combined weight of the trailer 22 and the cargo and the method 100 automatically adjusts the brake coefficient to the calculated brake coefficient. In another aspect, the method 100 includes notifying the user of the calculated brake coefficient and the user may choose to accept the calculated brake coefficient.

At block 108D, the operating parameter is a navigation route and the controller 38 generates the navigation route by processing the trailer information. For instance, the trailer height may be processed to identify any underpasses or tunnels, which may not accommodate the height of the trailer 22 and generate a route that bypasses the identified underpass and/or tunnel. Additionally, the trailer width and length may be processed to locate turns that may require the vehicle 10 to significantly reduce its speed to navigate the turn safely. It should be appreciated that the controller 38 may generate a plurality of routes for the user to select.

Accordingly, a system 32 and method 100 for adjusting an operating parameter of a vehicle 10 by processing trailer information is provided. The system 32 and method 100 optimizes the performance of the vehicle 10 by taking into consideration trailer information that may affect the operation of the vehicle 10, such as the brake coefficient, the drive mode of the vehicle 10, and the routes traveled by the vehicle 10. Further, the system 32 and method 100 is configured to adjust the operating parameter of the vehicle 10 based on the trailer information of a selected trailer profile and, thus, the driving experience is tuned to the trailer 22 being towed.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for adjusting an operating parameter of a vehicle, the vehicle including a hitch configured for coupling with a trailer, the system adjusting the operating parameter of the vehicle by processing a trailer information, the system comprising:
a sensor for detecting a trailer coupled to the hitch of the vehicle; and
a controller including a data processing hardware and a memory hardware, the memory hardware storing instructions that when executed on the data processing hardware cause the data processing hardware to perform operations comprising:
processing the trailer information to change the vehicle operating parameter to a predetermined operating parameter if the trailer is coupled to the hitch, wherein the vehicle operating parameter is a vehicle component that influences at least one of a control and travel of the vehicle.

2. The system as set forth in claim 1, wherein the trailer information is at least one of a trailer type, a trailer length, a trailer, height, a trailer width and a trailer weight.

3. The system as set forth in claim 2, wherein the sensor is configured to detect the trailer weight.

4. The system as set forth in claim 2, wherein the sensor is configured to detect the width of the trailer and the height of the trailer.

5. The system as set forth in claim 4, wherein the sensor is an optical device.

6. The system as set forth in claim 2, wherein the predetermined operating parameter is a driving mode.

7. The system as set forth in claim 6, wherein the driving mode is a trailer mode.

8. The system as set forth in claim 7, wherein the controller turns off a cruise control function of the vehicle if the trailer is coupled to the hitch.

9. The system as set forth in claim 2, wherein the predetermined operating parameter is a navigation route and the controller generates the navigation route by processing the trailer information.

10. The system as set forth in claim 2, wherein the predetermined operating parameter is a brake coefficient.

11. A method for adjusting an operating parameter of a vehicle, the vehicle including a hitch configured for coupling with a trailer, the system adjusting the operating parameter of the vehicle by processing a trailer information, the method comprising:
detecting if a trailer is coupled to the hitch of the vehicle; and
processing the trailer information to change the vehicle to a predetermined operating parameter if the trailer is coupled to the hitch.

12. The method as set forth in claim 11, wherein the trailer information is at least one of a trailer type, a trailer length, a trailer, height, a trailer width and a trailer weight.

13. The method as set forth in claim 12, wherein the predetermined operating parameter is a driving mode.

14. The method as set forth in claim 13, wherein the driving mode is a trailer mode.

15. The method as set forth in claim 14, including determining if the vehicle is in a regular haul mode or a trailer haul mode and alerting a user that the vehicle is in a regular haul when the trailer is coupled to the hitch.

16. The method as set forth in claim 11, including determining if a cruise control function of the vehicle is on and automatically turning off the cruise control function if the trailer is coupled to the hitch.

17. The method as set forth in claim 11, wherein the predetermined operating parameter is a navigation route.

18. The method as set forth in claim 17, wherein the controller generates the navigation route by processing the trailer information.

19. The method as set forth in claim 18, wherein the navigation route is a plurality of navigation routes, each of the plurality of navigation routes including a notice for a sharp turn.

20. The method as set forth in claim 11, wherein the predetermined operating parameter is a brake coefficient.
